(19) United States
(12) Patent Application Publication
(10) Pub. No.: US 2010/0109308 A1
(43) Pub. Date: May 6, 2010

(54) DETACHABLE PROTECTIVE DEVICE FOR A VEHICLE

(76) Inventor: Craig Gordon, Pompano Beach, FL (US)

Correspondence Address: Michael L. Diaz;Diaz and Associates, Suite 200, 555 Republic Drive, Plano, TX, 75074, US

(21) Appl. No.: 12/046,543

(22) Filed: Mar. 12, 2008

Related U.S. Application Data
(60) Provisional application No. 60/906,403, filed on Mar. 12, 2007.

(51) Int. Cl. B60J 11/00

(52) U.S. Cl. 280/770

(57) ABSTRACT

A device and method for protecting a vehicle. The device provides protection to a first vehicle. The protective device includes a main body having an impact absorbing region. The protective device also includes a plurality of magnetic segments affixed to the main body providing sufficient magnetic force for attaching the protective device to the vehicle. The protective device is configured for deploying from within a second vehicle parked adjacent to the first vehicle. The protective device is attached to the first vehicle to prevent damage caused by impact from the second vehicle. The impact absorbing region preferably includes two horizontally aligned foam tubes and a foam strip located between the two foam tubes.

### RELATED APPLICATIONS

This utility application claims the benefit of U.S. Provisional Patent Application Ser. No. 60/906,403 by Craig A. Gordon, filed Mar. 12, 2007, and is hereby incorporated by reference.

### BACKGROUND OF THE INVENTION

1. Field of the Invention

This invention relates to protective devices. Specifically, and not by way of limitation, the present invention relates to a detachable device for protecting a portion of a vehicle.

2. Description of the Related Art

There are many situations where vehicles must be parked extremely close together. In particular, in controlled environments, such as in valet parking lots or automobile repair shops, vehicles are parked very close to conserve limited parking space. However, there are problems associated with parking vehicles so close together. Specifically, it can be quite difficult for the driver to exit or enter a vehicle without opening the door and hitting the adjacent vehicle. Thus, it is quite common for damage to result from parking vehicles so close together. A device is needed which protects a portion of a vehicle to allow a user to open a vehicle door parked in close proximity to another vehicle without damaging either vehicle.

There are various existing devices which are used to protect vehicles against inadvertent damage from other vehicles. For example, there are devices which are attached to a large portion of the side of a vehicle to prevent another vehicle's door from hitting and damage a person's vehicle. However, since the vehicles are parked in an uncontrolled environment, these protective devices must cover a significant portion of the vehicle, because it is not known where the other vehicles may strike the protected vehicle. In addition, for use in public parking areas, most of these devices have anti-theft devices to prevent the theft of the protective devices. Thus, these existing protective devices are cumbersome to use, complex and expensive.

Although there are no known prior art teachings of a system or method such as that disclosed herein, prior art references that discuss subject matter that bears some relation to matters discussed herein are U.S. Patent Application Publication Number US 2003/0062732 to Molina (Molina), U.S. Pat. No. 5,312,145 to McNeil (McNeil), and U.S. Pat. No. 5,188,407 to Villaveces et al. (Villaveces).

Molina discloses a protector device for side doors of a vehicle. The protector device includes an elongated flexible protector member attached with a pair of magnetic sheets to a side door of a vehicle. However, Molina does not teach or suggest a device which is smaller than the width of the vehicle or a device which can be easily attached to an adjacent vehicle's door. Molina suffers from the disadvantage of using a cumbersome anti-theft mechanism (see FIG. 2), which requires the attachment of the protective device by opening a vehicle door.

McNeil discloses an apparatus for protecting the side of a vehicle. The apparatus includes a sheet of impact absorbing material bonded to a sheet of magnetic material. The apparatus is encased in a cover and configured in a series of panels to cover a significant portion of the side portion of the vehicle. However, McNeil does not disclose a device which covers only a portion of the vehicle's door. McNeil is a cumbersome device having a width which covers both a front and rear door.

Villaveces discloses a door protecting device having an elongated main body portion with a magnetic material on one side and a terminal flap which is inserted in the crack of the vehicle door. Villaveces does not teach or suggest a device which is easily attachable to an adjacent vehicle. Villaveces requires the placement of the terminal flap within the crack of the user's door, and not the door of the adjacent vehicle.

All of the existing devices are configured to be used on a user's vehicle and not an adjacent vehicle. In addition, these existing protective devices are configured for use in uncontrolled areas, where the protective devices must be secured with anti-theft devices and must be sufficiently large enough to cover an unspecified area.

A device is needed which is easily attachable to an adjacent vehicle. In particular, it would be desirable to have a device which enables the user to attach the device to an adjacent vehicle while still within the interior of the parked vehicle. It is an object of the present invention to provide such a device and method.

### SUMMARY OF THE INVENTION

The present invention is a device and method for protecting a vehicle. In one aspect, the present invention is directed to a device which provides protection to a first vehicle. The protective device includes a main body having an impact absorbing region. The protective device also includes a plurality of magnetic segments affixed to the main body providing sufficient magnetic force for attaching the protective device to the vehicle. The protective device is configured for deploying from within a second vehicle parked adjacent to the first vehicle. The protective device is attached to the first vehicle to prevent damage caused by impact from the second vehicle. The impact absorbing region preferably includes two horizontally aligned foam tubes and a foam strip located between the two foam tubes.

In another aspect, the present invention is a method of protecting a first vehicle. The method begins by parking a second vehicle in close proximity to a first vehicle. Next, a protective device is affixed to the first vehicle. The protective device includes a main body, an impact absorbing region affixed to the main body, and a plurality of magnetic segments affixed to the main body providing sufficient magnetic force for attaching the protective device to the vehicle. The protective device is configured for deploying from within a second vehicle parked adjacent to the first vehicle

### BRIEF DESCRIPTION OF THE DRAWINGS

FIG. 1 is a side view of a protective device in the preferred embodiment of the present invention;

FIG. 2 illustrates a front view of the protective device removed from the vehicle;

FIG. 3 illustrates a rear view of the protective device of FIG. 2;

FIG. 4 is a side view of the impact absorbing region of the protective device of FIG. 2;

FIG. 5 illustrates an enlarged view of a corner of the protective device;

FIG. 6 is a side view of the protective device attached to the vehicle;

FIG. 7 is a side view of the protective device attached to a front fender; and

FIG. 8 is a flow chart illustrating the steps of utilizing the protective device according to the teachings of the present invention.

### DESCRIPTION OF THE INVENTION

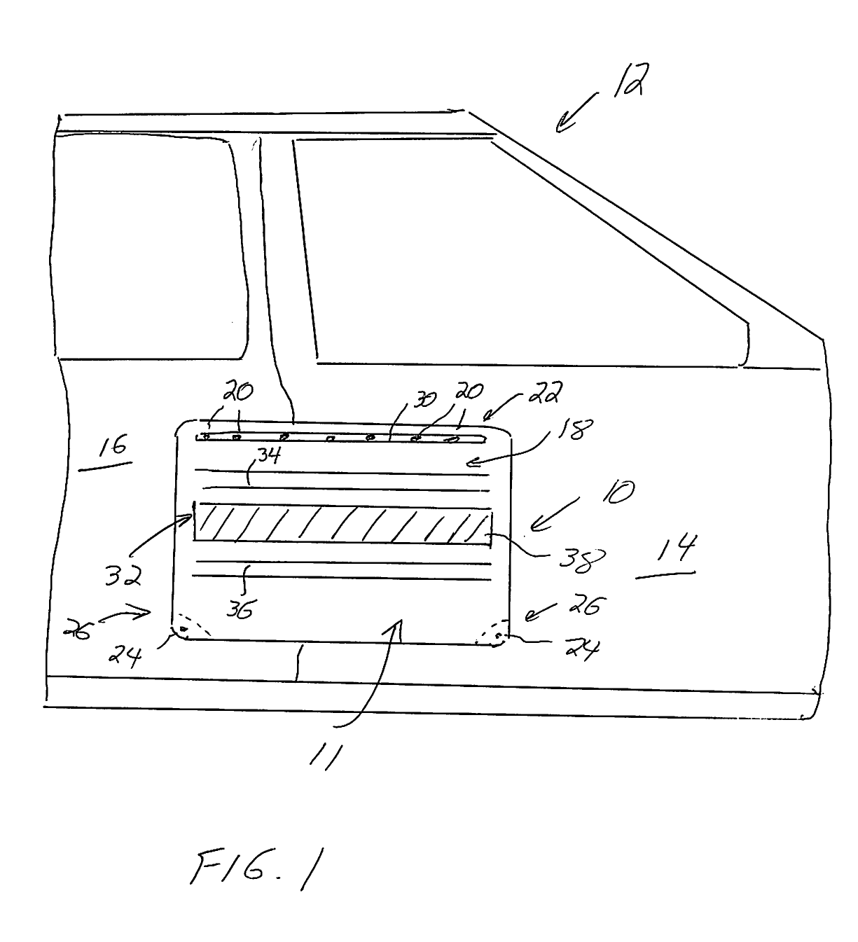

The present invention is a device and method for protecting vehicles parked in close proximity to each other. FIG. 1 is a side view of a protective device 10 in the preferred embodiment of the present invention. The protective device 10 is attachable to a vehicle 12 having a front door 14 and a back door 16. The protective device has a main body 11 having an exterior surface 18. The protective device includes a plurality of magnetic segments embedded within an interior portion of the protective device. In the preferred embodiment of the present invention, a series of upper magnetic segments 20 are located on a top portion 22 of the protective device. In addition, the protective device includes two lower magnetic segments 24 positioned in lower corners 26 of the protective device. It should be understood that the magnetic segments may be positioned anywhere on the protective device whereby sufficient magnetic attraction is attained to attach the protective device to a portion of the vehicle. Preferably, the magnetic segments are neodymium disc magnets mounted to an upper magnetic strip 30 positioned along the top portion 22 of the protective device.

The protective device includes an impact absorbing region 32 for absorbing impacts and protecting a covered area of a vehicle from any impacts. The impact absorbing region may be constructed of any material and in any configuration to protect the protected vehicle from damage incurred from impact by another vehicle. In the preferred embodiment of the present invention, the impact absorbing region includes a plurality of closed cell foam tubes 34 and 36 positioned parallel to each other. Between the foam tubes may be positioned a closed cell foam strip 38.

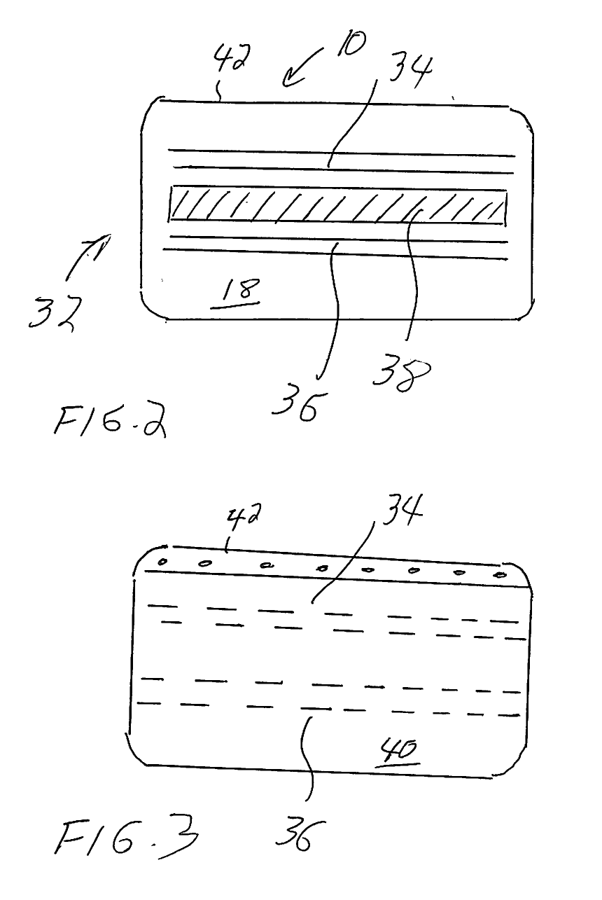

FIG. 2 illustrates a front view of the protective device 10 removed from the vehicle. FIG. 3 illustrates a rear view of the protective device 10 of FIG. 2. The protective device includes the exterior surface 18 (see FIG. 2) and an interior surface 40 (see FIG. 3). Preferably, the magnetic segments, the tubes 34 and 36, and the strip 38 are imbedded between the exterior surface and the interior surface of the protective device. The interior and exterior surfaces are preferably constructed of a vinyl material. However, any resilient flexible material may be used. In addition, although the impact absorbing region 32 shows tubes and a foam strip, the impact absorbing region may be constructed of any impact absorbing material and configured in any fashion and still remain in the scope of the present invention. The protective device may also include a reinforced perimeter border 42. In addition, the exterior surface may include a logo, design, and textual message for display.

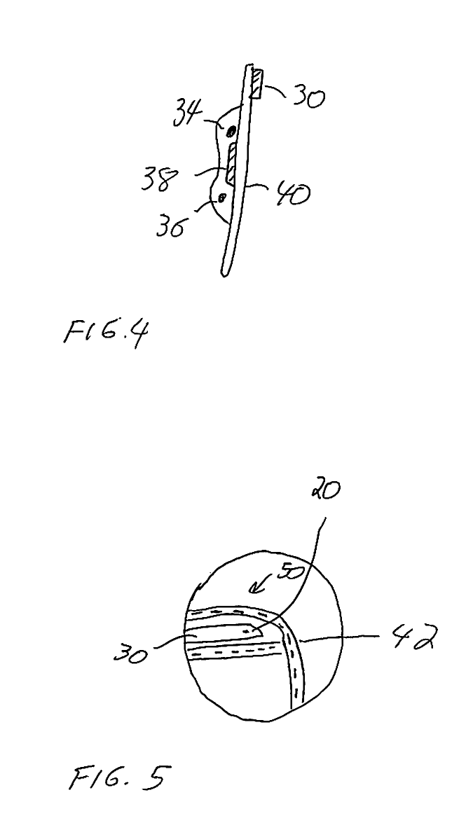

FIG. 4 is a side view of the impact absorbing region 32 of the protective device 10 of FIG. 2. FIG. 3 illustrates the tubes positioned between the exterior and interior surfaces. The tubes preferably protrude outwardly to provide a padding to absorb impacts.

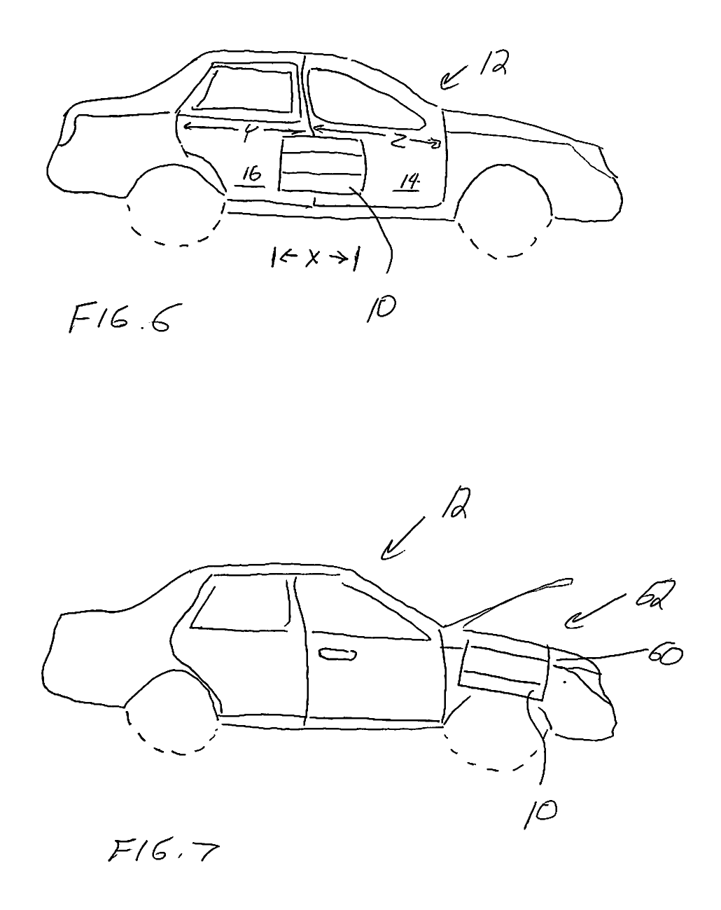

FIG. 5 illustrates an enlarged view of a corner 50 of the protective device 10. The magnetic segment may be stitched in an interior of the protective device, between the exterior and interior surfaces. All of the magnetic segments are preferably located between the exterior and interior surfaces to prevent contact of the magnets against the surface of the vehicle.

FIG. 6 is a side view of the protective device 10 attached to the vehicle 12. In the preferred embodiment of the present invention, a width X of the protective device 10 is smaller than a width Z of the front door 14 or a width Y of the rear door 16 (preferably having dimensions of 26 inches by 18 inches). Because the present invention is for use in a controlled environment, a protective zone of a smaller dimension is only necessary. A smaller protective device is preferred to allow ease in deployment and removal of the protective device.

FIG. 7 is a side view of the protective device 10 attached to a front fender 60. The protective device may be attached anywhere on the vehicle. As depicted in FIG. 7, the protective device may be positioned on a front fender. The protective device may then be useful in protecting the vehicle when a person is servicing an interior engine compartment 62 of the vehicle.

In an alternate embodiment of the present invention, a magnetic strip or metallic strip may be affixed to a wall (not shown). The protective device may be attached to the wall, at the affixed wall strip, thereby providing protection when a vehicle is parked in close proximity to a wall.

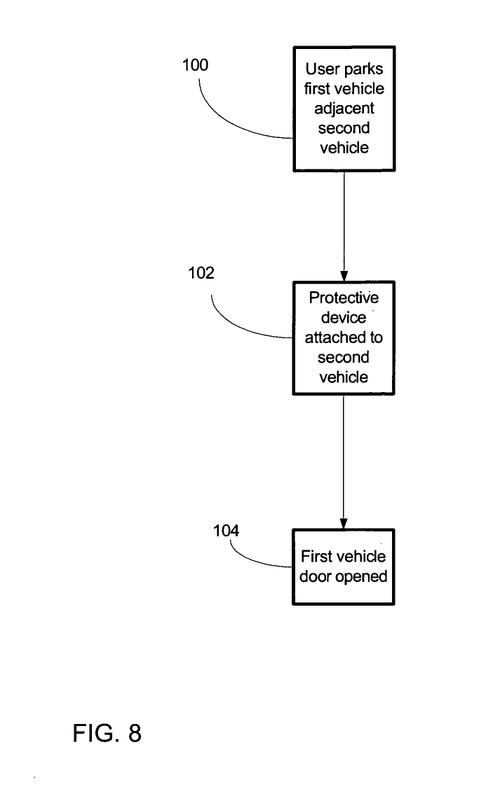

FIG. 8 is a flow chart illustrating the steps of utilizing the protective device 10 according to the teachings of the present invention. With reference to FIGS. 1-8, the method will now be explained. The method begins in step 100 where a user parks a first vehicle (not shown) in close proximity to a second vehicle 12 or wall. Next, in step 102, the protective device 10 is attached to the second vehicle in a position along a side of the vehicle where impact of the driver's door (of first vehicle) may potentially contact the second vehicle. Preferably, the driver of the first vehicle may attach the protective device while still seated in the vehicle by passing the protective device through the driver's window and attaching it to the second vehicle. Because the protective device is relatively small in comparison to existing devices, the protective device may be easily deployed from a sitting position in the first vehicle. Alternatively, the protective device may be attached to a wall to which the first vehicle is parked. Next, in step 104, the first vehicle door may be opened. The driver may open the door without concern in damaging the vehicle of the second vehicle.

The present invention provides a device for protecting vehicles in controlled environments, such as a valet parking lot. Because the present invention is utilized for a specific situation, i.e., a controlled environment, the protective device may be small without any type of anti-theft device. Furthermore, unlike other existing protective devices, the present invention is for specific use in attachment to a second vehicle to which a first vehicle is parked in close proximity.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A protective device for a first vehicle, the protective device comprising:
a main body;
an impact absorbing region affixed to the main body; and
a plurality of magnetic segments affixed to the main body providing sufficient magnetic force for attaching the protective device to the vehicle;
wherein the protective device is configured for deploying from within a second vehicle parked adjacent to the first vehicle;
whereby the protective device is attached to the first vehicle to prevent damage caused by impact from the second vehicle.

2. The protective device of claim 1, further comprising a magnetic strip positioned on an upper portion of the main body.

3. The protective device of claim 2, wherein the magnetic segments includes a plurality of magnetic discs affixed to the magnetic strip.

4. The protective device of claim 1, wherein the plurality of magnetic segments includes magnetic segments located in lower corners of the main body.

5. The protective device of claim 1, wherein the impact absorbing region includes a plurality of horizontally aligned tubes imbedded within the main body.

6. The protective device of claim 5, wherein the impact absorbing region includes a foam strip positioned between the plurality of tubes.

7. The protective device of claim 1 wherein the main body has a width smaller than a width of a conventional vehicle door.

8. The protective device of claim 1, wherein the main body includes a reinforced perimeter border.

9. The protective device of claim 1, wherein the protective device is adapted for attachment to a wall to which the first vehicle is parked in close proximity.

10. The protective device of claim 1, wherein the protective device is adapted for attachment to the fender of the first vehicle.

11. A method of protecting a first vehicle, the method comprising the steps of:
parking a second vehicle in close proximity to a first vehicle; and
affixing a protective device to the first vehicle, wherein the protective device includes:
a main body;
an impact absorbing region affixed to the main body; and
a plurality of magnetic segments affixed to the main body providing sufficient magnetic force for attaching the protective device to the vehicle;
wherein the protective device is configured for deploying from within a second vehicle parked adjacent to the first vehicle.

12. The method of protecting a first vehicle of claim 11, wherein the step of affixing a protective device to the first vehicle includes affixing the protective device by a person located in the second vehicle.

13. The method of protecting a first vehicle of claim 11 wherein the protective device includes a magnetic strip positioned on an upper portion of the main body.

14. The method of protecting a first vehicle of claim 12, wherein the magnetic segments includes a plurality of magnetic discs affixed to the magnetic strip.

15. The method of protecting a first vehicle of claim 11, wherein the plurality of magnetic segments includes magnetic segments located in lower corners of the main body.

16. The method of protecting a first vehicle of claim 11, wherein the impact absorbing region includes a plurality of horizontally aligned tubes imbedded within the main body.

17. The method of protecting a first vehicle of claim 11, wherein the impact absorbing region includes a foam strip positioned between the plurality of tubes.

18. The method of protecting a first vehicle of claim 11, wherein the main body has a width smaller than a width of a conventional vehicle door.

19. The method of protecting a first vehicle of claim 11, further comprising the step of attaching the protective device to a wall to which the first vehicle is parked in close proximity.
